(19) United States
(12) Patent Application Publication
(10) Pub. No.: US 2025/0007157 A1
(43) Pub. Date: Jan. 2, 2025

(54) ANTENNA, ANTENNA ARRAY AND ELECTRONIC APPARATUS

(71) Applicants: Beijing BOE Sensor Technology Co., Ltd., Beijing (CN); BOE TECHNOLOGY GROUP CO., LTD., Beijing (CN)

(72) Inventors: Yiming WANG, Beijing (CN); Xiaoqiang YANG, Beijing (CN); Cuiwei TANG, Beijing (CN); Wei ZHAO, Beijing (CN); Lu CHEN, Beijing (CN); Zixiang LIN, Beijing (CN); Chuncheng CHE, Beijing (CN)

(21) Appl. No.: 18/292,910

(22) PCT Filed: Aug. 18, 2022
(86) PCT No.: PCT/CN2022/113224

§ 371 Date: Jan. 28, 2024

(51) Int. Cl. H01Q 3/36

(52) U.S. Cl. CPC H01Q 3/36

(57) ABSTRACT

An antenna, an antenna array and an electronic apparatus are provided. The antenna includes a phase adjusting structure, a driving structure, a radiating structure, a reference electrode layer, and an isolation layer. The driving structure is electrically connected to the phase adjusting structure to provide a driving voltage to the phase adjusting structure, the radiating structure is configured to transmit the received microwave signal to the phase adjusting structure and radiate the adjusted microwave signal; the isolation layer has a first opening, an orthographic projection of the first opening on a plane where the reference electrode layer is located at least partially overlaps with an orthographic projection of the radiating structure on the plane, does not overlap with an orthographic projection of the driving structure on the plane, and an orthographic projection of the isolation layer on the plane covers the orthographic projection of the driving structure on the plane.

### TECHNICAL FIELD

The present disclosure relates to the field of communication technology, and in particular to an antenna, an antenna array and an electronic apparatus.

### BACKGROUND

With the rapid development of the information age, a wireless terminal with high integration, miniaturization, multifunction, and low cost has gradually become a trend of the communication technology. An antenna is an important device in wireless communication with performances directly affecting the quality of information communication. The antenna is developing towards ultra-wide band, function diversification, miniaturization and intellectualization to meet the requirements of science and technology and industrial development.

### SUMMARY

The present invention is directed to solve at least one of the problems in the prior art, and provides an antenna, an antenna array and an electronic apparatus.

In a first aspect, embodiments of the present disclosure provide an antenna, including a phase adjusting structure, a driving structure, a radiating structure, a reference electrode layer, and an isolation layer; the phase adjusting structure is between the reference electrode layer and the isolation layer, the driving structure is electrically connected to the phase adjusting structure and is configured to provide a driving voltage to the phase adjusting structure for adjusting a phase of a received microwave signal by the phase adjusting structure, and the radiating structure is configured to transmit the received microwave signal to the phase adjusting structure and radiate the microwave signal adjusted by the phase adjusting structure; and the isolation layer has a first opening, an orthographic projection of the first opening on a plane where the reference electrode layer is located at least partially overlaps with an orthographic projection of the radiating structure on the plane where the reference electrode layer is located, but does not overlap with an orthographic projection of the driving structure on the plane where the reference electrode layer is located, and an orthographic projection of the isolation layer on the plane where the reference electrode layer is located covers the orthographic projection of the driving structure on the plane where the reference electrode layer is located.

In some embodiments, the radiating structure includes a first radiating portion, the first radiating portion is on a side of the isolation layer close to the reference electrode layer, and is connected to one end of the phase adjusting structure, and an orthographic projection of the first radiating portion on the plane where the reference electrode layer is located and the orthographic projection of the first opening on the plane where the reference electrode layer is located at least partially overlap with each other.

In some embodiments, the radiating structure further includes a third dielectric substrate and a second radiating portion sequentially arranged on a side of the isolation layer away from the phase adjusting structure, and orthographic projections of any two of the first radiating portion, the second radiating portion and the first opening on the plane where the reference electrode layer is located at least partially overlap with each other.

In some embodiments, centers of the orthographic projections of the first opening, the first radiating portion and the second radiating portion on the plane where the reference electrode layer is located coincide with each other.

In some embodiments, the orthographic projection of the second radiating portion on the plane where the reference electrode layer is located is located within the orthographic projection of the first opening on the plane where the reference electrode layer is located.

In some embodiments, the phase adjusting structure includes a phase shifter, the phase shifter includes a first dielectric substrate, a second dielectric substrate, a tunable dielectric layer, a first transmission line and a second transmission line; the first dielectric substrate and the second dielectric substrate are opposite to each other, the tunable dielectric layer is between the first dielectric substrate and the second dielectric substrate, the first transmission line is on a side of the first dielectric substrate close to the tunable dielectric layer, and the second transmission line is on a side of the second dielectric substrate close to the tunable dielectric layer, the first radiating portion includes a first radiating component and a second radiating component, the first radiating component is electrically connected to the first transmission line, and the second radiating component is electrically connected to the second transmission line.

In some embodiments, the first transmission line and the first radiating component are in the same layer and directly connected to each other; and/or the second transmission line and the second radiating component are in the same layer and are directly connected to each other.

In some embodiments, the radiating structure is on a side of the isolation layer away from the phase adjusting structure, an end of the phase adjusting structure is coupled to the radiating structure through the first opening.

In some embodiments, a center of the orthographic projection of the first opening on the plane where the reference electrode layer is located coincides with a center of the orthographic projection of the radiating structure on the plane where the reference electrode layer is located.

In some embodiments, the isolation layer has a plurality of first openings, and the plurality of first openings have the same rotation center.

In some embodiments, an orthographic projection of the rotation center of the plurality of first openings on the plane where the reference electrode layer is located coincides with an orthographic projection of a center of the radiating structure on the plane where the reference electrode layer is located.

In some embodiments, the phase adjusting structure includes a phase shifter, the phase shifter includes a first dielectric substrate, a second dielectric substrate, a tunable dielectric layer, a first transmission line and a second transmission line; the first dielectric substrate and the second dielectric substrate are opposite to each other, the tunable dielectric layer is between the first dielectric substrate and the second dielectric substrate, the first transmission line is on a side of the first dielectric substrate close to the tunable dielectric layer, and the second transmission line is on a side of the second dielectric substrate close to the tunable dielectric layer, the driving structure includes a first driving line and a second driving line, the first driving line is electrically connected to the first transmission line, and the second driving line is electrically connected to the second transmission line.

In some embodiments, the first driving line and the first transmission line are in the same layer; and/or the second driving line and the second transmission line are in the same layer.

In some embodiments, the reference electrode layer is a reflective layer.

In a second aspect, embodiments of the present disclosure provide an antenna array, which includes a plurality of antennas, each of which is the antenna in any one of the above embodiments.

In some embodiments, the antenna array further includes a feeding source and transceiver modules; the feeding source is on an array surface formed by the plurality of antennas, and the transceiver module is electrically connected to the feeding source and is configured to feed electricity to the feeding source and process a microwave signal received by the feeding source.

In some embodiments, the feeding source includes any one of a loudspeaker, a helical antenna, a micro-strip line.

In some embodiments, the antenna array further includes a control module electrically connected to the driving structure in each antenna.

In a third aspect, embodiments of the present disclosure provide an electronic apparatus, which includes the antenna array in any one of the above embodiments.

### BRIEF DESCRIPTION OF DRAWINGS

FIG. 1 is a schematic diagram of a structure of layers of an exemplary antenna.

FIG. 2 is a schematic diagram of a portion of an exemplary phase shifter.

FIG. 3 is a cross-sectional view taken along a line A-A′ of FIG. 2.

FIG. 4 is a schematic diagram of an exemplary phase shifter.

FIG. 5 is a schematic diagram of a structure of layers of an antenna according to an embodiment of the present disclosure.

FIG. 6 is a schematic diagram illustrating a correspondence relationship among a phase shifter, a radiating structure, a driving structure, and an isolation layer according to an embodiment of the present disclosure.

FIG. 7 is a schematic diagram illustrating a correspondence relationship between a second radiating portion and an isolation layer according to an embodiment of the present disclosure.

FIG. 8 is another schematic diagram illustrating a correspondence relationship between a second radiating portion and an isolation layer according to an embodiment of the present disclosure.

FIG. 9 is another schematic diagram illustrating a correspondence relationship among a phase shifter, a radiating structure, a driving structure, and an isolation layer according to an embodiment of the present disclosure.

FIG. 10 is a schematic diagram of a structure of layers of another antenna according to an embodiment of the present disclosure.

FIG. 11 is another schematic diagram illustrating a correspondence relationship among a phase shifter, a driving structure and an isolation layer according to an embodiment of the present disclosure.

FIG. 12 is a schematic diagram of an antenna array according to an embodiment of the present disclosure.

FIG. 13 is a schematic diagram of another antenna array according to an embodiment of the present disclosure.

### DETAIL DESCRIPTION OF EMBODIMENTS

In order to enable one of ordinary skill in the art to better understand the technical solutions of the present disclosure, the present disclosure will be described in further detail with reference to the accompanying drawings and the detailed description.

Unless defined otherwise, technical or scientific terms used herein shall have the ordinary meaning as understood by one of ordinary skill in the art to which the present disclosure belongs. The terms “first”, “second”, and the like used in the present disclosure are not intended to indicate any order, quantity, or importance, but rather are used for distinguishing one element from another. Further, the term “a”, “an”, “the”, or the like used herein does not denote a limitation of quantity, but rather denotes the presence of at least one element. The term “comprising”, “including”, or the like means that the element or item preceding the term contains the element or item listed after the term and its equivalent, but does not exclude other elements or items. The term “connected”, “coupled”, or the like is not limited to physical or mechanical connections, but may include electrical connections, whether direct or indirect connections. The terms “upper”, “lower”, “left”, “right”, and the like are used only for indicating relative positional relationships, and when the absolute position of an object being described is changed, the relative positional relationships may also be changed accordingly.

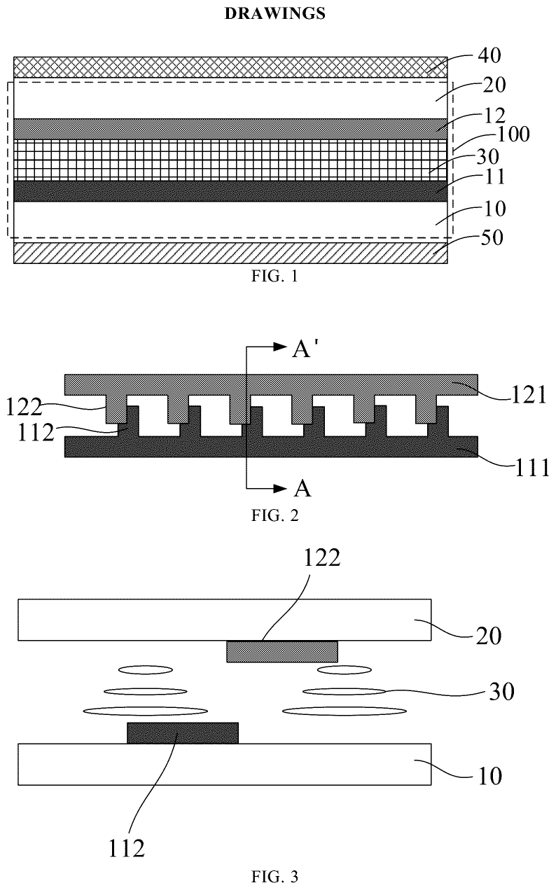

A space-feed array antenna is divided into a reflective array antenna and a transmission array antenna. The space-feed array antenna belongs to a passive antenna and is used for modulating incident waves and radiating the modulated incident waves. FIG. 1 is a schematic diagram of a structure of layers of an exemplary antenna. Referring to FIG. 1, by taking a reflective array antenna as an example, each antenna of the reflective array antenna includes a phase adjusting unit 100, a radiating structure 40, and a reflective layer/reference electrode layer 50. The reflective layer/reference electrode layer 50 may be a reflective ground. The phase adjusting unit 100 may be a phase shifter for adjusting a phase of a microwave signal received by the radiating structure 40, and the modulated microwave signal is radiated out through the radiating structure 40.

The phase shifter may be a liquid crystal phase shifter. The phase shifter may be a one wire phase shifter or a twin wire differential phase shifter. In the embodiment of the present disclosure, as an example, the phase shifter is a differential phase shifter. A tunable dielectric layer in the phase shifter is a liquid crystal layer.

FIG. 2 is a schematic diagram of a portion of an exemplary phase shifter. FIG. 3 is a cross-sectional view taken along a line A-A′ of FIG. 2. As shown in FIGS. 1 to 3, the phase shifter includes a first transmission line 11 arranged on the first dielectric substrate 10 and a second transmission line 12 arranged on the second dielectric substrate 20, and a liquid crystal layer 30 between the first transmission line 11 and the second transmission line 12. The first transmission line 11 includes a first main line 111, and a plurality of first branches 112 connected to different positions of the first main line 111 in an extending direction of the first main line 111; the second transmission line 12 includes a second main line 121 and a plurality of second branches 122 connected to different positions of the second main line 121 in an extending direction of the second main line 121. Orthographic projection of a first branch 112 and a second branch 122 corresponding to each other on the first dielectric substrate 10 at least partially overlap with each other, defining an overlapping region (i.e., a capacitive region) located between orthographic projections of the first main line 111 and the second main line 121 on the first dielectric substrate 10. A bias voltage is applied between the first main line 111 and the second main line 121, so that an electric field is formed in the capacitive region to change the dielectric constant of liquid crystal molecules of the liquid crystal layer 30, thereby realizing the phase shift of the microwave signal.

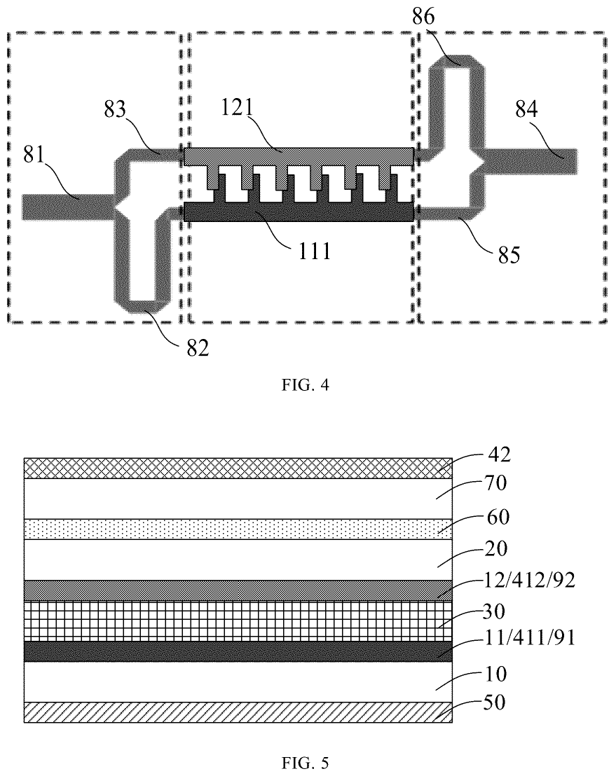

Further, since the differential liquid crystal phase shifter is mainly characterized by operating in a differential mode, it has a higher phase shifting efficiency than the one wire phase shifter. However, in order to provide a differential-mode signal, a first BALUN component and a second BALUN component need to be added at an input end and an output end of the phase shifter, respectively, as shown in FIG. 4; the first BALUN component includes a main path 81, a first branch 82, and a second branch 83; the second BALUN component includes a main path 84, a first branch 85, and a second branch 86. For the first BALUN component, first ends of the first branch 82 and the second branch 83 are connected to the main path 81, a second end of the first branch 82 is connected to a first end of the first main line 111, and a second end of the second branch 83 is connected to a first end of the second main line 121. For the second BALUN component, first ends of the first branch 85 and the second branch 86 are connected to the main path 84, a second end of the first branch 85 is connected to a second end of the first main line 111, and a second end of the second branch 86 is connected to a second end of the second main line 121. In addition, the first branch 82 of the first BALUN component and the second branch 86 of the second BALUN component each are a meander line, so that the first branch 82 and the second branch 83 of the first BALUN component have a phase difference of 180° therebetween, and the first branch 85 and the second branch 86 of the second BALUN component have a phase difference of 180° therebetween. In this case, as an example, the main path 81 of the first BALUN component is connected to the radiating structure 40, and the main path 84 of the second BALUN component is an open circuit. When the radiating structure 40 receives a microwave signal and transmits the microwave signal to the first branch 82 of the first BALUN component, the radio frequency signal fed into the first transmission line 11 by the first branch 82 of the first BALUN component and the radio frequency signal fed into the second transmission line 12 by the second branch 83 of the first BALUN component have a phase difference of 180° therebetween, and are transmitted to the first branch 85 and the second branch 86 of the second BALUN component via the first transmission line 11 and the second transmission line 12, respectively, so that the radio frequency signals are restored and output as the microwave signals with the same phase and the same amplitude, which are then radiated out by the radiating structure.

Before describing the embodiments of the present disclosure, it should be noted that a BALUN (balance-unbalance) component is a three-port device that can be applied in a microwave radio frequency device, and is a radio frequency transmission line transformer that converts a matching input into a differential input, and can be used for exciting a differential line, an amplifier, a wideband antenna, a balanced mixer, a balanced frequency multiplier and a modulator, a phase shifter 80, and any circuit design that requires transmission of signals with a same amplitude and a 180° phase difference on two lines. Two outputs of the BALUN component have a same amplitude and opposite phases. In the frequency domain, this means that there is a phase difference of 180° between the two outputs; in the time domain, this means that a voltage of one balanced output is a negative value of a voltage of the other balanced output.

Only one exemplary structure of the phase shifter is given above, but the phase shifter in the embodiment of the present disclosure is not limited thereto, and various forms of phase shifters may be applied to the antenna in the embodiment of the present disclosure, and are not listed herein.

The inventors have found that a driving structure in the antenna for applying the bias voltages between the first main line 111 and the second main line 121 may include a first driving line on the first dielectric substrate 10 and a second driving line on the second dielectric substrate 20. Since the first driving line and the second driving line are arranged around the phase shifter of the antenna, when a microwave signal is incident to the antenna, the microwave signal may be irradiated onto the first driving line and the second driving line to cause electromagnetic response, which deteriorates the performance of the antenna.

In view of the above technical problems, embodiments of the present disclosure provide an antenna, and an antenna array including the antenna and an electronic apparatus. The following description is made with reference to specific examples.

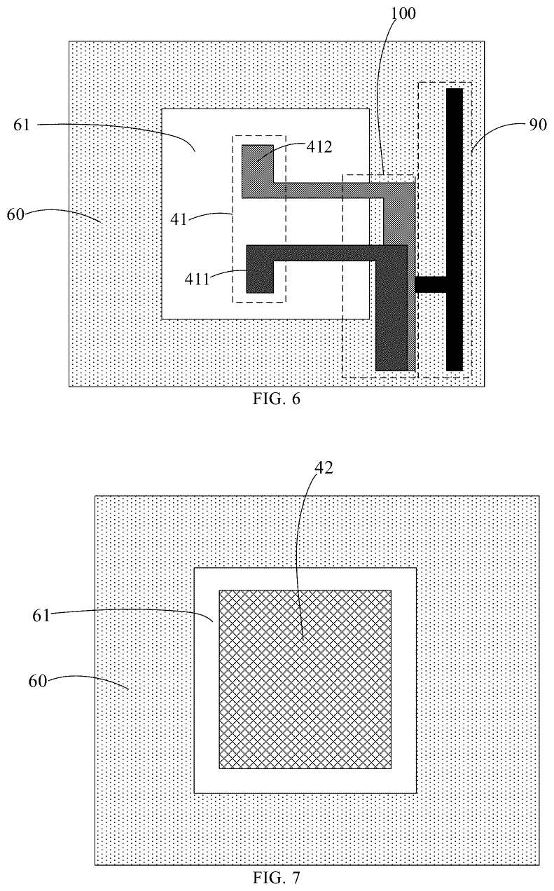

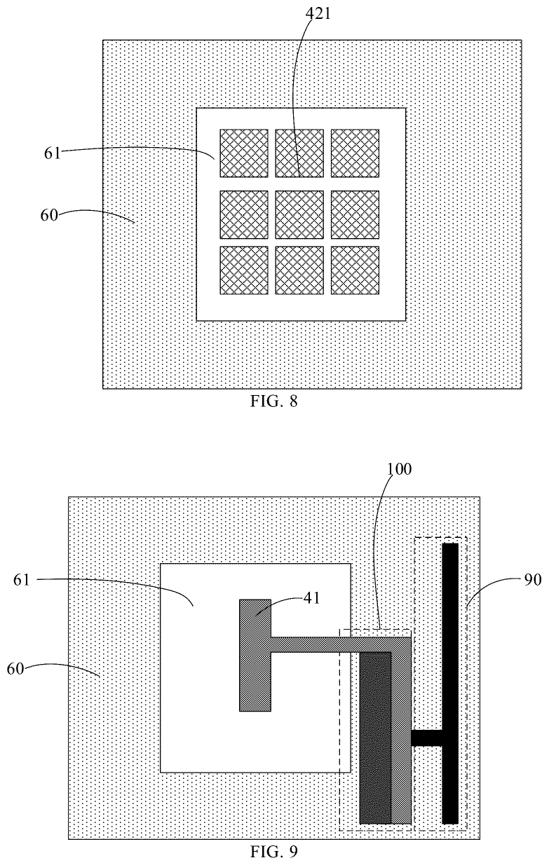

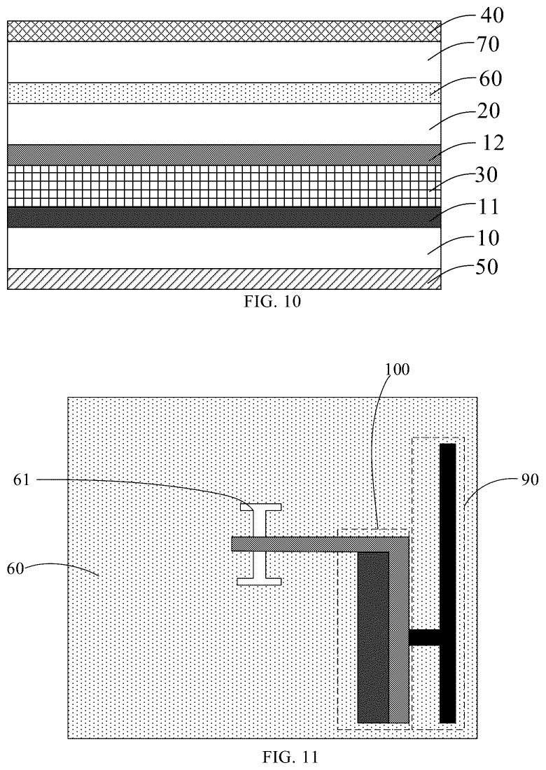

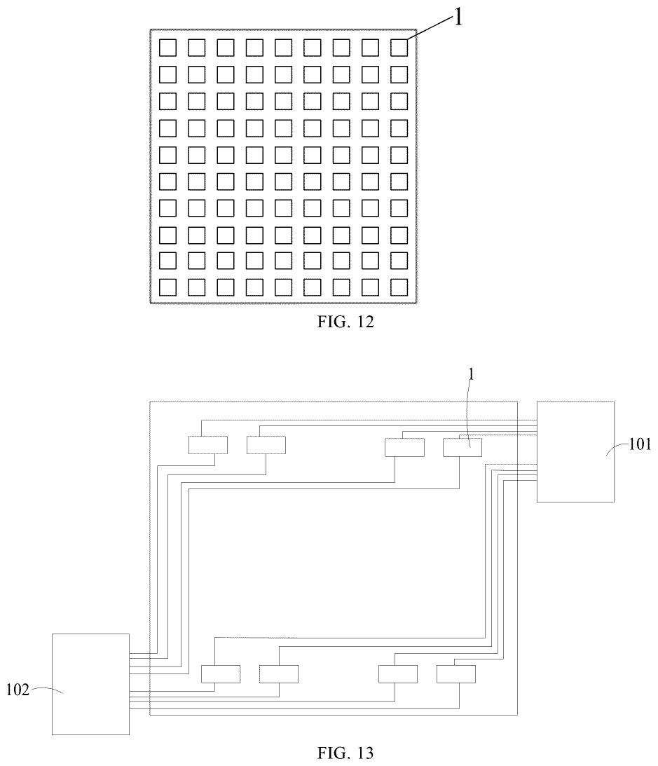

FIG. 5 is a schematic diagram of a structure of layers of an antenna according to an embodiment of the present disclosure. FIG. 6 is a schematic diagram illustrating a correspondence relationship among a phase shifter, a radiating structure, a driving structure, and an isolation layer according to an embodiment of the present disclosure. FIG. 7 is a schematic diagram illustrating a correspondence relationship between a second radiating portion and an isolation layer according to an embodiment of the present disclosure. FIG. 8 is another schematic diagram illustrating a correspondence relationship between a second radiating portion and an isolation layer according to an embodiment of the present disclosure. FIG. 9 is another schematic diagram illustrating a correspondence relationship among a phase shifter, a radiating structure, a driving structure, and an isolation layer according to an embodiment of the present disclosure. FIG. 10 is a schematic diagram of a structure of layers of another antenna according to an embodiment of the present disclosure. FIG. 11 is another schematic diagram illustrating a correspondence relationship among a phase shifter, a driving structure and an isolation layer according to an embodiment of the present disclosure.

In a first aspect, as shown in FIGS. 5 to 11, an embodiment of the present disclosure provides an antenna, which includes a phase adjusting structure, a driving structure 90, a radiating structure 40, a reference electrode layer 50, and an isolation layer 60; the reference electrode layer 50, the phase adjusting structure and the isolation layer 60 are sequentially stacked; the driving structure 90 is electrically connected to the phase adjusting structure, and is configured to provide a driving voltage to the phase adjusting structure for adjusting the phase of the received microwave signal by the phase adjusting structure; the radiating structure 40 is configured to transmit the received microwave signal to the phase adjusting structure and radiate the microwave signal adjusted by the phase adjusting structure. The isolation layer 60 has a first opening 61, an orthographic projection of the first opening 61 on a plane where the reference electrode layer 50 is located (the plane of the reference electrode layer 50) at least partially overlaps with an orthographic projection of the radiating structure 40 on the plane of the reference electrode layer 50, but does not overlap with an orthographic projection of the driving structure 90 on the plane of the reference electrode layer 50; an orthographic projection of the isolation layer 60 on the plane of the reference electrode layer 50 covers the orthographic projection of the driving structure 90 on the plane of the reference electrode layer 50.

The isolation layer 60 with the first opening 61 is provided in the antenna of the embodiment of the present disclosure, and is configured to block the driving structure 90. In this way, the problem, that the microwave signal may be irradiated onto the driving structure 90 when the antenna receives the microwave signal to cause the electromagnetic response and the performance of the antenna is deteriorated, can be effectively avoided.

In some examples, the phase adjusting unit includes, but is not limited to, a phase shifter 100. When the phase adjusting unit is the phase shifter 100, it may adopt the above structure for the phase shifter 100. That is, the phase shifter 100 may be a liquid crystal phase shifter 100. In other words, the phase shifter 100 employs a liquid crystal layer 30 as a tunable dielectric layer. Specifically, the phase shifter 100 may include the first dielectric substrate 10, the second dielectric substrate 20, the liquid crystal layer 30 between the first dielectric substrate 10 and the second dielectric substrate 20, the first transmission line on the first dielectric substrate 10 at a side close to the liquid crystal layer 30, and the second transmission line on the second dielectric substrate 20 at a side close to the liquid crystal layer 30. The first transmission line may include the first main line, and the plurality of first branches connected to different positions of the first main line in the extending direction of the first main line; the second transmission line may include the second main line, and the plurality of second branches connected to different positions of the second main line in the extending direction of the second main line. The first branches and the second branches are arranged in a one-to-one correspondence, and the orthographic projections of the first branch and the second branch corresponding to each other on the first dielectric substrate 10 at least partially overlap with each other. The phase shifting of the microwave signal is achieved by applying a voltage between the first main line 111 and the second main line 121 by the driving structure 90 to adjust a dielectric constant of the liquid crystal layer 30 between the first branches and the second branches.

The first branches and the second branches are arranged in a one-to-one correspondence. Furthermore, the plurality of first branches are periodically arranged, and similarly, the plurality of second branches are also periodically arranged. For example: a distance between every two adjacent first branches is constant; and a distance between every two adjacent second branches is constant. In some examples, an overlapping area between the orthographic projections of the first branch and the second branch corresponding to each other on the first dielectric substrate 10 is constant. For example: the plurality of first branches may have a same width, and the plurality of second branches may have a same width. Of course, the plurality of first branches may have a same length, and the plurality of second branches may have a same length.

In some examples, the first main line and the second main line in the phase shifter 100 each may employ a transmission line, which is a straight line segment. Extending directions of the first main line and the second main line may be parallel to each other, which can help to realize the miniaturization of the phase shifter 100 and the high integration of the antenna. Alternatively, the first main line and the second main line may alternatively be curved, and a shape of each of the first main line and the second main line is not limited in the embodiment of the present disclosure.

Further, the radiating structure 40 may include a first radiating portion 41 on a side of the isolation layer 60 close to the reference electrode layer 50 and a second radiating portion 42 on a side of the isolation layer 60 away from the reference electrode layer 50, and a third dielectric substrate 70 disposed between the isolation layer 60 and the second radiating portion 42. Orthographic projections of any two of the first radiating portion 41, the second radiating portion 42 and the first opening 61 in the isolation layer 60 on the plane where the reference electrode layer 50 is located overlap with each other. In this way, it can be ensured that the microwave signal received by the second radiating portion can be transmitted to the first radiating portion 41 through the first opening 61 and then transmitted to the phase shifter 100 through the first radiating portion 41, and that the microwave signal modulated by the phase shifter 100 can be transmitted to the first radiating portion 41, and in turn is transmitted to the second radiating portion 42 through the first opening 61, and is radiated out by the second radiating portion 42.

In one example, the first radiating portion 41 may include a first radiating component 411 and a second radiating component 412. For example: the first radiating component 411 is directly connected to the first main line of the first transmission line and the second radiating component 412 is directly connected to the second main line of the second transmission line. In this case, the first radiating component 411 may be disposed in the same layer as the first transmission line, that is, the first radiating component 411 is disposed on a side of the first dielectric substrate 10 close to the liquid crystal layer 30. The second radiating component 412 may be disposed in the same layer as the second transmission line, that is, the second radiating component 412 is disposed on a side of the second dielectric substrate 20 close to the liquid crystal layer 30. Thus, the first radiating component 411 and the first transmission line may be formed in one process, and the second radiating component 412 and the second transmission line may be formed in one process, which can not only reduce the process cost, but also realize the high integration, the lightweight and thinness of the antenna. It should be understood that an orthographic projection of each of the first radiating component 411 and the second radiating component 412 in the first radiating portion 41 on the layer where the reference electrode layer 50 is located overlaps with the orthographic projection of the second radiating portion 42 on the layer where the reference electrode layer 50 is located, so that the transmission efficiency of the microwave signal can be improved and the transmission loss can be reduced by providing the second radiating portion 42.

In some examples, the first radiating component 411, the second radiating component 412, and the second radiating portion 42 each include, but are not limited to, a patch electrode, a dipole, or any other antenna structure. The first radiating component 411, the second radiating component 412 and the second radiating portion 42 all adopting patch electrodes may or may not have the same shape. For example: the shape of the patch electrode may be any one of a rectangular shape, a circular shape and a triangular shape or any combination thereof. The specific shape of the patch electrode is not limited in the embodiments of the present disclosure.

In some examples, the second radiating portion 42 may be a planar structure, and may alternatively include a plurality of sub-structures 421. For example, the plurality of sub-structures 421 are arranged in an array. Regardless of the structure of the second radiating portion 42, the orthographic projection of the second radiating portion 42 on the plane of the reference electrode layer 50 may be located within the orthographic projection of the first opening 61 of the isolation layer 60 on the plane of the reference electrode layer 50. In one example, an orthographic projection of a center of the second radiating portion 42 on the plane of the reference electrode layer 50 coincides with an orthographic projection of a center of the first opening 61 on the plane of the reference electrode layer 50. Alternatively, the orthographic projection of the center of the second radiating portion 42 on the plane of the reference electrode layer 50 may substantially coincide with the orthographic projection of the center of the first opening 61 on the plane of the reference electrode layer 50. That is, there is a slight distance between the orthographic projection of the center of the second radiating portion 42 on the plane of the reference electrode layer 50 and the orthographic projection of the center of the first opening 61 on the plane of the reference electrode layer 50.

In one example, when the phase shifter 100 is a differential phase shifter 100, ends of the first transmission line and ends of the second transmission line are connected to the BALUN components. For example, one end of the first transmission line and one end of the second transmission line are connected to the first BALUN component, and the other end of the first transmission line and the other end of the second transmission line are connected to the second BALUN component. In this case, the first radiating portion 41 may have an integral structure, and may be connected to the main path of the first BALUN component. In this case, in one example, orthographic projections of centers of the first radiating portion 41, the second radiating portion 42 and the first opening 61 of the isolation layer 60 on the plane in which the reference electrode layer 50 is located coincide with each other.

Further, the orthographic projections of the first radiating portion 41 and the second radiating portion 42 on the plane of the reference electrode layer 50 are both located in the orthographic projection of the first opening 61 of the isolation layer 60 on the plane of the reference electrode layer 50. For example: the first radiating portion 41 and the second radiating portion 42 both adopt patch electrodes, and the shape of the patch electrode may be rectangular, and correspondingly, a shape of the first opening 61 of the isolation layer 60 may also be rectangular. Alternatively, the shapes of the first radiating portion 41, the second radiating portion 42, and the first opening 61 of the isolation layer 60 may be different.

It should be noted that, in the antenna according to the embodiment of the present disclosure, the radiating structure 40 may only include the first radiating portion 41, and it is not required to include the second radiating portion 42 in the radiating structure 40, which is also possible and within the scope of the embodiments of the present disclosure.

In one example, the radiating structure 40 may be located on a side of the isolation layer 60 away from the phase shifter 100. In this case, orthographic projections of any two of one end of the phase shifter 100, the first opening 61 of the isolation layer 60, and the radiating structure 40 on the plane of the reference electrode layer 50 overlap with each other. The phase shifter 100 is the above phase shifter 100, as an example, orthographic projections of any two of the main path of the first BALUN component, the first opening 61 of the isolation layer 60, and the radiating structure 40 on the plane of the reference electrode layer 50 overlap with each other.

Further, the first opening 61 may be a slit structure, and a shape of the slit structure includes, but is not limited to, a linear shape, an I-shape or the like. The isolation layer 60 may include one or more first openings 61. When the isolation layer 60 includes one first opening 61, the orthographic projection of the center of the first opening 61 on the plane of the reference electrode layer 50 coincides with the orthographic projection of the center of the radiating structure 40 on the plane of the reference electrode layer 50. Alternatively, the orthographic projection of the center of the first opening 61 on the plane of the reference electrode layer 50 substantially coincides with the orthographic projection of the center of the radiating structure 40 on the plane of the reference electrode layer 50, that is, there is a slight distance between the orthographic projection of the center of the first opening 61 on the plane of the reference electrode layer 50 and the orthographic projection of the center of the radiating structure 40 on the plane of the reference electrode layer 50. When the isolation layer 60 includes the plurality of first openings 61, the plurality of first openings 61 have a common rotation center or symmetry center, and an orthographic projection of the rotation center or symmetry center of the plurality of first openings 61 on the plane of the reference electrode layer 50 coincides with the orthographic projection of the center of the radiating structure 40 on the plane of the reference electrode layer 50. Alternatively, the orthographic projection of the rotation center or symmetry center of the plurality of first openings 61 on the plane of the reference electrode layer 50 substantially coincides with the orthographic projection of the center of the radiating structure 40 on the plane of the reference electrode layer 50, that is, there is a slight distance between the orthographic projection of the rotation center or symmetry center of the plurality of first openings 61 on the plane of the reference electrode layer 50 and the orthographic projection of the center of the radiating structure 40 on the plane of the reference electrode layer 50.

No matter which of the above structures is adopted by the radiating structure 40 in the embodiment of the present disclosure, the driving structure 90 in the embodiment of the present disclosure may include a first driving line 91 and a second driving line 92. The first driving line 91 is electrically connected to the first transmission line in the phase shifter 100, and the second driving line 92 is connected to the second transmission line. In this case, the first driving line 91 may be disposed in the same layer as the first transmission line, that is, the first driving line 91 is disposed on a side of the first dielectric substrate 10 close to the liquid crystal layer 30. The second driving line 92 may be disposed in the same layer as the second transmission line, that is, the second driving line is disposed on a side of the second dielectric substrate 20 close to the liquid crystal layer 30. In this way, the first driving line 91 and the first transmission line may be formed by a single patterning process, and the second driving line 92 and the second transmission line may be formed by a single patterning process, which not only can reduce the process cost, but also improve the integration of the antenna and achieve the lightweight and thinness of the antenna. In some examples, the reference electrode layer 50 includes, but is not limited to, a ground electrode. In one example, the reference electrode layer may alternatively be a reflective layer. That is, the antenna of the embodiments of the present disclosure is a reflective antenna. In the embodiment of the present disclosure, the reference electrode layer 50 may be an entire-surface (planar) structure. If there are special requirements on the performance of the antenna, such as suppressing specific resonance, improving bandwidth, etc., a specific structure, such as a defected ground structure and an electromagnetic band-gap structure, may be adopted instead of the planar reference electrode layer 50.

In some examples, the first dielectric substrate 10 and the second dielectric substrate 20 in the embodiments of the present disclosure each may be a glass substrate, a plastic substrate, a PCB, a ceramic substrate, or the like. A material of each of the radiating structure 40, the driving structure 90 and the reference electrode layer 50 include, but are not limited to, a metal material such as copper, aluminum, or molybdenum or the like, or a non-metal material with conductive properties such as indium tin oxide or the like.

In the antenna according to the embodiment of the present disclosure, different voltages can be applied by the driving structure 90 to the phase adjusting structure, so that the liquid crystal molecules in the phase adjusting structure can be oriented, and the phase shifting effect of more than 360 degrees can be applied to the incident electromagnetic wave by adjustability of the liquid crystal molecules. This effect enables each antenna to independently perform phase compensation of more than 360 degrees on the incident electromagnetic wave. The isolation layer 60 is provided, to prevent the incident electromagnetic wave from penetrating through the isolation layer 60 and directly striking onto the driving structure 90, thereby avoiding the deterioration of the performance of the antenna due to the electromagnetic response of the driving structure 90.

In a second aspect, the embodiments of the present disclosure further provide an antenna array (an array of the antennas 1), including a plurality of antennas 1 (e.g., M×N antennas 1, M≥1, M≥2). Each antenna 1 may be the antenna 1 in any one of the above embodiments.

In some examples, the array of antennas 1 in the embodiments of the present disclosure further includes a feeding source and a transceiver module. The feeding source is located on an array surface (a surface of the array) formed by the plurality of antennas 1, and the transceiver module is electrically connected to the feeding source and is configured to feed electricity to the feeding source and process the microwave signal received by the feeding source. Furthermore, the feeding source adopts the form of a loudspeaker, a helical antenna 1, a micro-strip antenna 1 or the like, and a feeding position may be selected from a positive feeding, a side feeding or other modes.

For the array of the antennas 1 of the embodiment of the present disclosure, when a plane wave incident in a direction is transmitted to the array surface, a phase of the wave at each unit may be extracted to obtain a phase compensation matrix. At a time, if a wave beam is required to be emitted towards a specified direction, the antennas 1 need to be loaded with different phases according to a theoretical calculation formula of a phased array. A control voltage for the liquid crystal phase shifter 100 is adjusted, and a difference between the output in the specified direction and the compensation matrix in the incident direction is calculated, so as to obtain a phase difference to be loaded to each antenna 1 when the wave is radiated in the specified direction, thereby realizing a value assignment process of a voltage matrix (obtaining a voltage assignment matrix). At the next moment, if energy needs to be radiated towards another direction, a second voltage assignment matrix is obtained in the same manner. Thereby, a direction of the outgoing wave beam may be dynamically adjusted, and the reconfigurable function of the wave beam is completed.

In some examples, the array of antennas 1 may also include a control module electrically connected to the driving structure 90 in each antenna 1. The control module independently controls the driving voltage on each antenna 1 to realize different phase compensation matrixes, thereby realizing beam scanning. For example: the driving structure 90 in each antenna 1 includes the first driving line 91 and the second driving line 92, the control module may include a first control module 101 and a second control module 102, the first control module 101 is connected to each first driving line 91 through a first lead, and the second control module 102 is connected to each second driving line 92 through a second lead. The first lead and the second lead each may be selected from a common wire, a flexible printed circuit (FPC), a thin film chip integrated circuit (COF), etc., which is not limited thereto. The connection between the first lead and the first driving line 91 and the connection between the second lead and the second driving line 92 may be selected from pin, soldering, bonding, or the like, which is not limited thereto. The connection between the first lead and the first control module 101 and the connection between the second lead and the second control module 102 may be selected from pin, soldering, bonding, clipping or the like, which is not limited thereto.

In a fourth aspect, an embodiment of the present disclosure further provides an electronic apparatus, which may include the antenna array described above. The electronic apparatus provided by the embodiments of the present disclosure further includes a transceiver unit, a radio frequency transceiver, a signal amplifier, a power amplifier, and a filtering unit. The antenna 1 in the electronic apparatus may be used as a transmitting antenna 1 or a receiving antenna 1. The transceiver unit may include a baseband and a receiving terminal, where the baseband provides a signal in at least one frequency band, such as 2G signal, 3G signal, 4G signal, 5G signal, or the like; and transmits the signal in the at least one frequency band to the radio frequency transceiver. After the signal is received by the antenna 1 in the electronic apparatus and is processed by the filtering unit, the power amplifier, the signal amplifier, and the radio frequency transceiver, the antenna 1 may transmit the signal to the receiving terminal (such as an intelligent gateway or the like) in the transceiver unit.

Further, the radio frequency transceiver is connected to the transceiver unit and is configured to modulate the signals transmitted by the transceiver unit or demodulate the signals received by the antenna 1 and then transmit the signals to the transceiver unit. Specifically, the radio frequency transceiver may include a transmitting circuit, a receiving circuit, a modulating circuit, and a demodulating circuit. After the transmitting circuit receives multiple types of signals provided by the baseband, the modulating circuit may modulate the multiple types of signals provided by the baseband, and then transmit the modulated signals to the antenna 1. The signals received by the antenna 1 are transmitted to the receiving circuit of the radio frequency transceiver, and transmitted by the receiving circuit to the demodulating circuit, and demodulated by the demodulating circuit and then transmitted to the receiving terminal.

Further, the radio frequency transceiver is connected to the signal amplifier and the power amplifier, which are in turn connected to the filtering unit connected to at least one antenna 1. In the process of transmitting signals by the electronic apparatus, the signal amplifier is used for improving a signal-to-noise ratio of the signals output by the radio frequency transceiver and then transmitting the signals to the filtering unit; the power amplifier is used for amplifying the power of the signals output by the radio frequency transceiver and then transmitting the signals to the filtering unit; the filtering unit specifically includes a duplexer and a filtering circuit, the filtering unit combines signals output by the signal amplifier and the power amplifier and filters out noise waves and then transmits the signals to the antenna 1, and the antenna 1 radiates the signals. In the process of receiving signals by the electronic apparatus, the signals received by the antenna 1 are transmitted to the filtering unit, which filters out noise waves in the signals received by the antenna 1 and then transmits the signals to the signal amplifier and the power amplifier, and the signal amplifier gains the signals received by the antenna 1 to increase the signal-to-noise ratio of the signals; the power amplifier amplifies the power of the signals received by the antenna 1. The signals received by the antenna 1 are processed by the power amplifier and the signal amplifier and then transmitted to the radio frequency transceiver, and the radio frequency transceiver transmits the signals to the transceiver unit.

In some examples, the signal amplifier may include various types of signal amplifiers, such as a low noise amplifier, without limitation.

In some examples, the electronic apparatus provided by the embodiments of the present disclosure further includes a power management unit connected to the power amplifier to provide the power amplifier with a voltage for amplifying the signal.

It should be understood that, the above embodiments are merely exemplary embodiments adopted to explain the principles of the present disclosure, and the present disclosure is not limited thereto. It will be apparent to one of ordinary skill in the art that various changes and modifications may be made therein without departing from the spirit and scope of the present disclosure, and such changes and modifications also fall within the scope of the present disclosure.

1. An antenna, comprising a phase adjusting structure, a driving structure, a radiating structure, a reference electrode layer, and an isolation layer; wherein the phase adjusting structure is between the reference electrode layer and the isolation layer, the driving structure is electrically connected to the phase adjusting structure and is configured to provide a driving voltage to the phase adjusting structure for adjusting a phase of a received microwave signal by the phase adjusting structure, and the radiating structure is configured to transmit the received microwave signal to the phase adjusting structure and radiate the microwave signal adjusted by the phase adjusting structure; and
the isolation layer has a first opening, an orthographic projection of the first opening on a plane where the reference electrode layer is located at least partially overlaps with an orthographic projection of the radiating structure on the plane where the reference electrode layer is located, but does not overlap with an orthographic projection of the driving structure on the plane where the reference electrode layer is located, and an orthographic projection of the isolation layer on the plane where the reference electrode layer is located covers the orthographic projection of the driving structure on the plane where the reference electrode layer is located.

2. The antenna of claim 1, wherein the radiating structure comprises a first radiating portion, the first radiating portion is on a side of the isolation layer close to the reference electrode layer, and is connected to one end of the phase adjusting structure, and an orthographic projection of the first radiating portion on the plane where the reference electrode layer is located and the orthographic projection of the first opening on the plane where the reference electrode layer is located at least partially overlap with each other.

3. The antenna of claim 2, wherein the radiating structure further comprises a third dielectric substrate and a second radiating portion sequentially arranged on a side of the isolation layer away from the phase adjusting structure, and orthographic projections of any two of the first radiating portion, the second radiating portion and the first opening on the plane where the reference electrode layer is located at least partially overlap with each other.

4. The antenna of claim 3, wherein centers of the orthographic projections of the first opening, the first radiating portion and the second radiating portion on the plane where the reference electrode layer is located coincide with each other.

5. The antenna of claim 3, wherein the orthographic projection of the second radiating portion on the plane where the reference electrode layer is located is located within the orthographic projection of the first opening on the plane where the reference electrode layer is located.

6. The antenna of claim 2, wherein the phase adjusting structure comprises a phase shifter, the phase shifter comprises a first dielectric substrate, a second dielectric substrate, a tunable dielectric layer, a first transmission line and a second transmission line; wherein the first dielectric substrate and the second dielectric substrate are opposite to each other, the tunable dielectric layer is between the first dielectric substrate and the second dielectric substrate, the first transmission line is on a side of the first dielectric substrate close to the tunable dielectric layer, and the second transmission line is on a side of the second dielectric substrate close to the tunable dielectric layer, the first radiating portion comprises a first radiating component and a second radiating component, the first radiating component is electrically connected to the first transmission line, and the second radiating component is electrically connected to the second transmission line.

7. The antenna of claim 6, wherein the first transmission line and the first radiating component are in a same layer and directly connected to each other; and/or the second transmission line and the second radiating component are in a same layer and are directly connected to each other.

8. The antenna of claim 1, wherein the radiating structure is on a side of the isolation layer away from the phase adjusting structure, and an end of the phase adjusting structure is coupled to the radiating structure through the first opening.

9. The antenna of claim 8, wherein a center of the orthographic projection of the first opening on the plane where the reference electrode layer is located coincides with a center of the orthographic projection of the radiating structure on the plane where the reference electrode layer is located.

10. The antenna of claim 8, wherein the isolation layer has a plurality of first openings, and the plurality of first openings have a same rotation center.

11. The antenna of claim 10, wherein an orthographic projection of the rotation center of the plurality of first openings on the plane where the reference electrode layer is located coincides with an orthographic projection of a center of the radiating structure on the plane where the reference electrode layer is located.

12. The antenna of claim 1, wherein the phase adjusting structure comprises a phase shifter, the phase shifter comprises a first dielectric substrate, a second dielectric substrate, a tunable dielectric layer, a first transmission line and a second transmission line; wherein the first dielectric substrate and the second dielectric substrate are opposite to each other, the tunable dielectric layer is between the first dielectric substrate and the second dielectric substrate, the first transmission line is on a side of the first dielectric substrate close to the tunable dielectric layer, and the second transmission line is on a side of the second dielectric substrate close to the tunable dielectric layer, the driving structure comprises a first driving line and a second driving line, the first driving line is electrically connected to the first transmission line, and the second driving line is electrically connected to the second transmission line.

13. The antenna of claim 12, wherein the first driving line and the first transmission line are in a same layer; and/or the second driving line and the second transmission line are in a same layer.

14. The antenna of claim 1, wherein the reference electrode layer is a reflective layer.

15. An antenna array, comprising a plurality of antennas, each of which is the antenna of claim 1.

16. The antenna array of claim 15, further comprising a feeding source and a transceiver module; wherein
the feeding source is on an array surface formed by the plurality of antennas, and
the transceiver module is electrically connected to the feeding source and is configured to feed electricity to the feeding source and process a microwave signal received by the feeding source.

17. The antenna array of claim 16, wherein the feeding source comprises any one of a loudspeaker, a helical antenna, a micro-strip line.

18. The antenna array of claim 15, further comprising a control module electrically connected to the driving structure in each of the plurality of antennas.

19. An electronic apparatus, comprising the antenna array of claim 15.

20. The antenna of claim 2, wherein the phase adjusting structure comprises a phase shifter, the phase shifter comprises a first dielectric substrate, a second dielectric substrate, a tunable dielectric layer, a first transmission line and a second transmission line; wherein the first dielectric substrate and the second dielectric substrate are opposite to each other, the tunable dielectric layer is between the first dielectric substrate and the second dielectric substrate, the first transmission line is on a side of the first dielectric substrate close to the tunable dielectric layer, and the second transmission line is on a side of the second dielectric substrate close to the tunable dielectric layer, the driving structure comprises a first driving line and a second driving line, the first driving line is electrically connected to the first transmission line, and the second driving line is electrically connected to the second transmission line.
